(19) United States
(12) Patent Application Publication
(10) Pub. No.: US 2026/0204195 A1
(43) Pub. Date: Jul. 16, 2026

(54) Resilient Image Capture System and Method of Use Thereof

(71) Applicant: The Elumenati, LLC, Milwaukee, WI (US)

(72) Inventors: Clement Shimizu, Minneapolis, MN (US); D'nardo Colucci, Milwaukee, WI (US); Clayton Hooker, Marshall, NC (US); Marco Silva, Avanca (PT)

(21) Appl. No.: 19/451,653

(22) Filed: Jan. 16, 2026

Related U.S. Application Data
(60) Provisional application No. 63/745,906, filed on Jan. 16, 2025.

(51) Int. Cl. G09G 3/00; G06T 7/80

(52) U.S. Cl. CPC G09G 3/006; G06T 7/80; G06T 2207/10144; G06T 2207/20224; G09G 2320/062; G09G 2320/0673; G09G 2320/0693

(57) ABSTRACT

A resilient image capture system and method of use is described. Embodiments of the system can be implemented to calibrate a display device in non-ideal lighting environment. The system can implement one or more methods to aid in calibrating the display device in the non-ideal lighting environment. A first method can be implemented to map UV coordinates between a display device and a camera.

### CROSS-REFERENCE TO RELATED APPLICATION

This application claims the benefit of U.S. Provisional Application No. 63/745,906, filed Jan. 16, 2025.

### BACKGROUND

Display systems often display rectangular images on flat screens. As these systems grow in scale and complexity, proper calibration and alignment of displayed imagery becomes essential to achieving accurate and reliable performance. This is particularly true in environments that rely on multiple display devices operating together to form a unified display. Multiple display device systems are widely used in entertainment, simulation, training, and visualization systems as a means of displaying digital content on physical surfaces.

As a display cannot directly observe an output by said display, it is difficult to verify and/or adjust a performance of the display without external devices. Manual calibration methods are commonly used, but they are time-consuming, require skilled operators, and often produce inconsistent results. These limitations become more pronounced when multiple display devices must be aligned across large or irregular surfaces, where even small geometric or photometric errors can degrade the quality of the final image. Currently, optical and perspective correction techniques must be employed to produce undistorted output on non-planar display surfaces. When using multiple display devices, this problem becomes more critical, as even tiny small errors in the correction can lead to image issues such as perspective distortion or image doubling.

A camera-based calibration system offers a means of addressing these challenges. By capturing images of the displayed output, a camera can provide the necessary feedback to evaluate and adjust display device performance. However, existing systems often require extensive setup, rely on restrictive assumptions about the display surface, and/or lack the precision needed for demanding applications such as immersive displays, projection mapping, or simulation environments. Additionally, many camera-based calibration approaches are not resilient to ambient light, motion, or other environmental disruptions that interfere with image acquisition.

Accordingly, a system is needed for calibrating one or more display devices using a camera-based calibration means that addresses the previously mentioned challenges efficiently.

### BRIEF DESCRIPTION OF THE DRAWINGS

FIG. 1 is a block diagram of a display device-camera calibration system according to one embodiment of the present invention.

FIG. 2 is a flow diagram of an image processing method according to one embodiment of the present invention.

FIG. 3 includes diagrams illustrative of the image processing method according to one embodiment of the present invention.

FIG. 4 is a flow diagram of a display device mapping method according to one embodiment of the present invention.

FIG. 5 includes diagrams illustrative of the display device mapping method according to one embodiment of the present invention.

FIG. 6 is a flow diagram of an auto-exposure mitigation method according to one embodiment of the present invention.

FIG. 7 includes diagrams illustrative of the auto-exposure mitigation method according to one embodiment of the present invention.

FIG. 8 is a flow diagram of an edge reconstruction method according to one embodiment of the present invention.

### DETAILED DESCRIPTION

Embodiments of the present invention include a resilient image capture system and method of use thereof. The resilient image capture system can include a control module, one or more display devices, and one or more cameras. The control module can be implemented to process images captured by the one or more cameras being displayed by the display device. A novel method of processing the images is provided herein. The resilient image capture system can be implemented to improve resilience in display calibration and surrounding improvements for handling real world issues. A method for acquiring display images can include capturing a positive image and an inverted image and computing differences between the images. Of note, this can be implemented to cancel out ambient light, background texture, and brightness differences. The described method can improve robustness of capture in many ways and simplify image processing. Typically, the captured images for calibration can be normalized such that a value of 0 may be the neutral brightness. To help improve robustness against real-world conditions, the resilient image capture system can integrate a display device-camera calibration subsystem.

In one embodiment, the resilient image capture system can include a display device-camera calibration (DDC) system. The DDC calibration system can be implemented to provide simplified image processing and to cancel ambient light, background texture, and brightness differences when calibrating a display device. In one instance, the DDC calibration system can be part of a display device-camera calibration pipeline.

A real camera can be a digital camera that is physically present in space. A virtual camera can be an idealized camera that may be created by reprojecting, distorting, and merging real cameras into a single image. A calibration camera can be a camera, either real or virtual, that may be used to calibrate a display system. Of note, cameras can have one or more problems including, but not limited to, flicker, strobing (e.g., unwanted flashing stemming from lights, or display devices being out of phase or frequency from camera capture), noise, incorrectly bright or dark pixels, dynamic range, and over or under exposure.

Exposure for a camera can be the amount of light acquired in a photo (e.g., shutter duration). Of note, this can be augmented by the sensitivity of the sensor (ISO and aperture). A manual exposure is a camera state in which the shutter duration, ISO, and aperture are explicitly set. An auto exposure is a camera state in which the camera's parameters (e.g., shutter duration, sensitivity, aperture, etc.) are automatically set in order to create a properly exposed image that is not too dark and not too bright.

A perfect lens is an ideal lens where the angular distortion is mathematically constant. For example, a fisheye lens with F-Theta distortion means that every constant step in from the optical axis on the imaging plane represents an equal step in angle. Real lenses often have optical distortion that deviates from a perfect lens. Lens calibration can help understand and correct these distortions. An extreme example would be OpenCV's fisheye calibration tool that un-distorts a fisheye into a rectilinear image. A rectilinear lens is a common type of lens where linear features are projected as lines. Most computer graphics rendering engines use rectilinear projection. A fisheye lens is an ultra-wide-angle lens that produces non-rectilinear projection. These lenses often have severe distortion and vignetting.

Embodiments of the present invention can include creating and/or implementing a virtual camera. By combining one or more real cameras (e.g., fisheye or standard) a virtual view can be generated. However, to effectively create a virtual camera the exact camera parameters position in XYZ, orientation (yaw, tilt roll), FOV, lens distortion parameters (R, U, V, a,b,c,d) must be known. To minimize the discontinuity at the seam between two real cameras in a virtual camera one must precisely know the parameters. If more than one real camera is used, they must be masked or blended to determine what happens on an overlap region.

The real cameras can be consolidated with distorted lenses into a single virtual camera with an ideal lens. The method for creating the virtual camera can include, but is not limited to, the following steps: (i) determining parameters of each real camera; (ii) distorting the real cameras by using texture projection of the image onto the display surface; and (iii) capturing the reprojected images with the virtual camera and potentially blending or masking the overlap regions.

In a first step, the real cameras parameters can be determined. If using a single real camera (or cameras with known distortion and known position), one can enter the camera parameters into a user interface. Using a preview of the resulting virtual camera's image, one can determine if virtual camera merge is sufficient or needs to be refined. For small changes an expert could manually tweak values in order to get satisfactory merge. However, this can become harder with multiple cameras and if there are a lot of unknown parameters, especially if multiple parameters produce a similar change to an image's appearance. For example, field of view (FOV) and camera distance can produce similar but slightly different changes. Lens distortion is another tricky thing to optimize manually.

In the second step, the system can distort the real cameras by using texture projection of the image onto the display surface. For each camera, a source image of each camera can be distorted. UV coordinates can be used to calculate the outgoing ray from the camera in world space. The precise outgoing rays can be computed by using the camera parameters and the lens parameters. Each ray can be raytraced onto the display surface. An XYZ hit position can be used to set the position. A camera mask can be used to help set the blend between overlapping cameras or to mask off unwanted areas of real cameras.

In the third step, the reprojected image can be captured with a virtual camera. A virtual camera can be placed into a virtual scene. The virtual camera can capture a picture of the distorted meshes after masking. The system can use the order of the real camera in the editor to determine which real cameras have priority if two cameras overlap and are not masked or blended. If a rectilinear virtual camera lens is needed, then traditional computer graphics rendering using perspective camera matrix can be implemented. If a wide-angle image (e.g., a fisheye rendering or 360 image) is needed, the system can use a cube map like capture rig to capture the entire virtual scene and then reproject it into a fisheye or 360 or other wide angle format using hardware acceleration. The resulting virtual scene can be able to reproject the real cameras into a virtual camera in real time. The optimization for the virtual camera can also be used to align display devices and display surfaces.

Embodiments of the present invention can provide a system and method to determine parameters of real cameras if they are unknown by annotating the real camera's image with “annotation hints” that are fed into a non-linear optimization algorithm that tries to minimize the error of the user supplied annotation hint value and the current value (given the camera parameter guess). The system can allow the user to check or uncheck specific camera parameters for being unknown or locked. A system can be implemented to supply an initial guess and a way to iterate or revert.

The system can provide an annotation tool for adding “annotation points” to a real camera's image. Each annotation point can be placed on a specific UV coordinate on a real camera image. An option allows the user to set that point to be a specific longitude point, a specific latitude point, a longitude-latitude point, or as a group of points that have the same longitude and/or latitude (without specifying the value). Each annotation point can show a different icon depending on if the point is a longitude or latitude or both, or if the point is a part of a group. Alternatively, other values such as radius, being part of a line, and plane may be implemented in the system. The user can select the points or move them on the image. Each annotation point can show an error that that point has. This is computed as the difference between the user supplied value and what the system can calculate as the value given the UV coordinate of the image, and the free parameters of the camera. For group points where a group of points has an unspecified longitude or latitude, the system can estimate the value as an average, and uses that average value to compute error. The user may then quickly find which annotation points have the worst error to make sure there are no typos or if the point is not placed correctly.

The scene allows the user to set specific parameters to be locked or unlocked. Parameter values can be bookmarked so that the system has a good starting point for optimization. In addition to camera position, orientation and lens distortion parameters, screen shape and position parameters can also be set or optimized for.

The system can implement a Levenberg-Marquardt damped least-squares solver for nonlinear least squares problems. The Levenberg-Marquardt solver can provide a good balance between speed and being well behaved when given a so-so starting point. Other solvers could be swapped in without substantial changes to the system.

When a user clicks “optimize”, the system can reformulate the annotation points and free parameters into a non-linear least squares problem. In the least-squares curve fitting problem: given a set of variables (Xi,yi), find the parameters B of a function y=F (x,B) so that the sum of the squares is minimized. In this case the X's are the annotation points coordinates, the Y's are the user supplied annotation hint values, and B are the free parameters. The Function F is our simulation of the camera system. Given an annotation point's position, and the system parameters (camera position, orientation, lens parameters, display shape) F will return its value for that specific annotation point. The error between the hint and the simulation can be computationally determined.

In one instance, the objective may be to minimize the sum of squared residuals:

$${\sum }_{i = 1}^{m} {[ {y}_{i} - f ( {x}_{i} , β ) ]}^{2}$$

For instance, a total between the user supplied hint and what the system has determined across all annotation points for a given set of free parameters can be summed. Then, by changing the free parameters and recomputing the total error the system can try to find the best guess for the free parameters that would minimize the total error.

The Levenberg-Marquardt algorithm can be applied and the system can compute a best guess for the free parameters. By illustrating the error to the operator, the operator can decide if the guess is good enough or if the solution needs to be improved. In practice, one rarely gets a satisfactory solution on the first try. As such, one would need to review the annotation points and add one or more parameters to improve the precision of placement. Sometimes the starting point can be insufficient, or too many variables are free. The algorithm may optimize the wrong parameters and come up with a (incorrect local maxima). By showing the errors of the points, the operator can improve the accuracy of placing points. The operator can lock parameters that they think are good enough. The operator can steer the progress by resetting single parameters to start the optimization from a new starting point that may be closer to the global minima. When the operator may be satisfied with the parameters, the current best guess can be saved to a settings file.

After the virtual camera has been created, a calibration dataset can be collected. Of note, the system can use either real cameras or a virtual camera. The dataset collection can be implemented to create a mapping between display device UV coordinates and a camera (real or virtual) UV coordinates. In one instance, multiple types of technology can be used to collect the dataset collection. However, the final collection may be used by one or more of the technologies.

In a first method, every pixel of the display devices displays a dot, then take a photo from the calibration camera, detect the dot position in camera UV coordinates. A table can be built that maps display pixel coordinates to the camera pixel coordinates. Of note, there are multiple issues with the first method. Namely, dataset collection takes a long time, pixel size may be smaller than camera resolving power, noise can cause issues, and knowing the “threshold level.”

In a second method, wavelets can be implemented. A wavelet is a frequency space methodology to capture a similar dataset. Instead of photographing each pixel one at a time, wavelets can be drawn and a photograph of each of the wavelets that correspond to frequency bands. In one instance, Haar wavelets can be implemented. Typically, one set of wavelets for horizontal bands and one set for vertical bands can be photographed. By combining the wavelets, the system can find the camera pixels that correspond to a specific row and column of display device pixels. As such, the system can create a mapping between display UV coordinates and a camera (real or virtual) UV coordinates.

In one example, 5 wavelet levels (or frequency bands) can be implemented. The 5 wavelet levels can correspond to 16 individual positions (e.g., spatial positions) that can be distinguished. The system can have one photo for each wavelet level in the horizontal direction and a second set for each wavelet level in the vertical direction. Of note, multiple display devices can be handled in a separate capture phase. The resolution of the wavelet capture can be 2wavelets, but it is ok for this to be less than the display device resolution because this can be interpolated. One can calculate a wavelet pattern required to generate a specific spatial position by converting the position index to binary. As can be appreciated, each 0 or 1 can correspond to a white or dark part of the image of the wavelet level for each bit index. Level 0 can be used only for overall screen masking. By combining the horizontal and vertical wavelets the system can create the mapping from any XY position of the display device to any XY position on the camera. The wavelet method is not without problems. Noise can cause issues, knowing the “threshold level,” hotspots, and dark spots are some known problems.

The data capture pipeline implemented by the system can be designed to handle a variety of issues. More specifically, problems with bright and dark areas, hotspots, noise, flicker, and rainbowing. In one instance, multiple exposures averaged (or mean) can help with noise flicker and rainbowing.

The system can implement a novel threshold finder. Often times there is a problem knowing what threshold to use to segment pixels into the white vs black state. A black feature in a bright area can be brighter than a white feature in a dark area. As can be appreciated, no single threshold level can fix this. Some attempts in prior systems use such tricks as applying a display mask to equalize the displayed image. Alternatively, prior systems decrease the contrast, try to automatically determine the level, or use regions attempt.

The system can implement an inverted rendering methodology instead of creating a single image and applying the threshold to the single image. The inverted rendering methodology can include, but is not limited to, the steps of: (i) taking one photo normally to get a positive image (may consist of multiple for denoising); (ii) inverting the image and taking a second photo (may consist of multiple for denoising) to get a negative image; (iii) computing positive minus negative, and (iv) applying a threshold. Of note, the system can do this in an image format that can handle negative values. Of significant note, by computing positive minus negative in image processing, the system does not need to know the threshold level. Everything can now be centered around zero. The system can use a threshold level on the difference from zero, but now this threshold can be used globally equally well for bright areas and dark areas. The system can take multiple exposures to find the image pair that has the highest threshold and use this because the highest threshold will represent the most accurate threshold. Of note, dark spots and hot spots can have better data after the inverted rendering method.

The system can be configured to help with cameras that have auto exposure. If a camera is in automatic exposure mode, there can be a problem with exposure changing between image pairs when showing the inverted image at course levels. For example, if 75 percent of the display is covered with white, when the image is inverted, the overall brightness will change and an automatic exposure camera will compensate causing a problem with the positive-negative system. To combat this, the system can create test patterns that discourage changes to auto exposure. In one example, instead of showing white and black test images, the system can convert white to black and white strips, and black to a 50% grey (this can be computed to be the 50% brightness not by RGB value, respecting the gamma of the display device). For instance, an overall brightness can be 50% (i.e., 25% white, 25% black, 50% gray). If those ratios are kept consistent then the exposure should maintain a single level.

In some instances, a signal that is sent by certain cameras is not what is received. The image may be transformed by “sharpening” or “compression and decompression.” Both of these operations will produce sharpened edges. The exact position of the signal edge is now changed by unwanted image processing. The image may also be blurred because of lens aberrations or resolution. The system can implement a novel signal sending methodology to combat edge artifacts.

The system can use the signal sending methodology combined with a signal reconstruction method to help eliminate edge artifacts. In one instance, a black and white stripe pattern can be drawn with a phase offset. The system can take photos for each phase offsets until a full 360 phase is finished. For example, seven steps would be 360/7 degrees in phase offset. For each pixel, the system can find a phase that represents the black part of the stripe. In one instance, the system can accomplish this by blurring the image sequence across phase. Blur can usually apply in XY for blurring across space, but the system can blur across time or phase. Of note, this can reduce the false edge and converts the hard edge to a smooth transition. For each pixel, the system can compare all of the phases. The darkest pixel index in the blurred phase represents the phase offset for that pixel to find the interior of the black part of the stripe. When applied to the entire image, the system can be able to capture the black region of the pattern as the darkest phase of the striped area. The system can capture the white part of the pattern as the gray part of the image. The system may then apply the positive-negative technique and can get a very clean image of the wavelet test pattern.

For each UV cell of a display, a set of wavelets that represent the set of camera pixels that correspond to it are needed. The system can get the set of camera pixels by multiplying the wavelets. A special image format can be implemented that allows for negative pixels and not a number (NaN) values for invalid areas. In one instance, the system can use a dictionary data structure to make the computation faster. The system can use masking to block out unwanted data. The system will then need to create a function that maps the UV of the display to the UV of the camera. The system can create a sparse data set of UV display to UV camera. A radial basis functions can be used to fit a smoothed function to the dataset and interpolate missing data, and extrapolate to areas where data was not captured. This can create a smooth continuous function. Next, the function can be converted to mesh. In one instance, the UV coordinates of the mesh can be in camera space. The XY position of the mesh can be in a display device space. After an image is drawn, the multiple display devices can warp the image so the image is virtually displayed from the perspective of the camera, even though the image is being drawn by the display devices.

The system can be configured to provide perspective display mapping. In instances where a perspective projection (accounting for the perspective of the viewer given the shape of a display surface) is used, the system can utilize ray tracing to convert the display UVs to camera outgoing rays. The system can then trace it into the display shape. Finally, by storing the hit position in the mesh, the system can reproject the user's view given the display shape. The system can implement a cubemap, 360 image, or use ray tracing to get a near perfect perspective. Alternatively, the system can use the UV of the display shape as a mesh value and do UV mapping. Of note, this may be useful when warping an image to a displays extents.

The system can be configured to compute an overlap region and blend edges. In one example, the system can use a hot edge cold edge method. They system can mark points on the mesh as being a cold edge if they are an edge of a blend that should be black and hot edge if they are an edge of a blend that should be 100. The system may then linearly interpolate (e.g., gamma corrected) to compute the blend zone. For displays where the blend zone can be locked vertically or horizontally, this approach works well. The approach does not often work for unaligned overlaps or masked display devices.

In another example, the system can project the displayed region from one display device to a different display device using a calibration camera as an intermediary. The system can get an overlap region. The overlap region can be an area where two display devices (or more) have overlap. In a first instance, a blend would be to draw this at 50% brightness. However, the system can do better to use a gradient. The system can implement an algorithm to find the hot and cold edges and more freely fade out to the cold edge, even if the cold edge is brought in by an optical camera mask. Of note, this function can be similar to the signed distance function as in OPENCV, but it has some differences. First, the algorithm always normalizes the line so it goes from white to black. Second, the algorithm normalizes the brightness so that if there are two or more display devices the sum always adds to 100%. The algorithm can be configured to account for the gamma of the display devices.

The system can be configured to provide black level uplift. The inversion of the blend zone can be a black level uplift region. The system can provide a UI to help dilate or contract the edge so that the edge may better match the display devices. However, a problem arises as the edge is often a hard edge and display devices often have a fence so that the black level is not perfectly flush with the display device. By dilating, the system can better match this fence. The system can create a set of control points that can be used to dilate the edge to varying degrees. In instances of a fuzzy black level region, the system can create a blurry edge using additional control points. By default, the system can use Gamma correct calculations to ensure black level uplift is done respecting the non-linearity of the display.

In one example embodiment, the display device-camera calibration pipeline can include at least one method for mapping display device UV coordinates to camera UV coordinates in non-ideal lighting conditions. The first method can include, but is not limited to, the steps described hereinafter. In a first step, the display device can be implemented to display a first set of horizontal wavelet patterns. In a second step, the camera can be configured to capture a first image. The first image can be of the first set of horizontal wavelet patterns. In a third step, the display device can display an inverted version of the first set of horizontal wavelet patterns. In a fourth step, the camera can capture a second image. The second image can be of the inverted version of the first set of horizontal wavelet patterns. In a fifth step, the control module can be configured to compute a first difference image by subtracting the second image from the first image. In a sixth step, the previously mentioned steps can be repeated for a first set of vertical wavelet patterns to compute a second difference image. In an seventh step, the control module can apply a threshold to the first difference image and the second difference image to classify pixels in each image as white or black, and the pixel classifications can be combined to determine a display device-to-camera mapping. The steps of displaying, capturing, and computing may be repeated for at least five different sets of horizontal wavelet patterns and five different sets of vertical wavelet patterns, and the steps of applying the threshold and combining the pixel classifications may be completed after ten difference images are computed.

The method may further include selecting a highest threshold margin from the ten difference images and using the selected highest threshold margin as the threshold. The method may also include encoding spatial positions of display device pixels by associating each set of wavelet patterns with a bit position of a binary index. As can be appreciated, a combination of corresponding horizontal sets of wavelet patterns and vertical sets of wavelet patterns can identify a unique horizontal position and a unique vertical position of the binary index. Typically, each bit position corresponds to a white region or black region of one of the sets of wavelet patterns.

In another example embodiment, the display device-camera calibration pipeline may include two or more methods. A first method can be for mapping display device UV coordinates to camera UV coordinates. A second method can be for systems where the camera has auto-exposure. A third method can be for transmitting and reconstructing a signal to reduce edge artifacts.

The first method for mapping display device UV coordinates to camera UV coordinates can include, but is not limited to, the steps described hereinafter. In a first step, a display device, a camera, and a control module can be provided. In a second step, the display device can display a plurality of wavelet patterns one at a time. The plurality of wavelet patterns can correspond to horizontally oriented frequency bands and vertically oriented frequency bands of the display device. In a third step, the camera can capture a positive image and an inverted image for each wavelet pattern of the plurality of wavelet patterns. In a fourth step, the control module can compute a plurality of difference images by subtracting a negative image from a positive image for each wavelet pattern of the plurality of wavelet patterns. In a fifth step, the control module can apply a threshold to the plurality of difference images about zero to classify pixels as representing a white region, a black region, or an invalid region. In a sixth step, the control module can combine classification results for each of the plurality of difference images to identify pairs of display UV coordinates and corresponding camera UV coordinates. The control module can be configured to record the identified pairs to form a mapping between display UV coordinates and camera UV coordinates and process the recorded mapping to fill missing or invalid entries by smoothing, interpolating, or extrapolating the recorded pairs.

In one instance, the step of applying a threshold to the plurality of difference images may include, but is not limited to, (i) identifying positive-valued pixels of the difference image having values above a first threshold and classifying the positive-valued pixels as corresponding to white regions of the first pattern; (ii) identifying negative-valued pixels of the difference image having values below a second threshold and classifying the negative-valued pixels as corresponding to black regions of the first pattern; (iii) identifying near-zero-valued pixels of the difference image having values within a third threshold range around zero and classifying the near-zero-valued pixels as invalid regions; and (iv) generating a thresholded image defined by pixels corresponding to the white regions, pixels corresponding to the black regions, and pixels marked as invalid or outside the image.

The second method for mitigating the camera having auto-exposure can include, but is not, limited to the following steps. In a first step, the control module can receive an input signal representing a black-and-white test pattern comprising a white region and a black region. In a second step, the control module can transform the input signal into a first transformed pattern by converting the white region into alternating black-and-white stripes and converting the black region into a gray region. In one instance, the gray region may have approximately 50% brightness as determined according to a gamma characteristic of the display device. In a third step, the display device can display the first transformed pattern. In a fourth step, the camera can capture a first image, the first image of the first transformed pattern. Of note, the first image may have an overall brightness comprising approximately 25% white, 25% black, and 50% gray. In a fifth step, the control module can transform the first transformed pattern into a second transformed pattern by applying a phase shift of approximately 180 degrees to the alternating black-and-white stripes of the first transformed pattern. In a sixth step, the display device can display the second transformed pattern. In a seventh step, the camera can capture a second image, the second image of the second transformed pattern. In an eighth step, the control module can combine the first image and the second image using a maximum-value operator to generate a first combined image. In a ninth step, the control module, the display device, and the camera can perform the steps of transforming, displaying, capturing, and combining for an inverted version of the input signal to generate a second combined image. In a tenth step, the control module can reconstruct the original black-and-white test pattern by subtracting the first combined image from the second combined image to produce a reconstructed image corresponding to the input signal.

The third method for transmitting and reconstructing a signal to reduce edge artifacts can include, but is not limited to, the steps described hereinafter. In a first step, the control module can generate a sequence of black-and-white stripe patterns. Each of the black-and-white stripe patterns can be drawn with a different phase offset. Typically, the phase offsets collectively can span approximately 360 degrees. In a second step, the display device can display the sequence of black-and-white stripe patterns. In a third step, the camera can capture a corresponding sequence of images. Each of the captured images can be associated with a respective phase offset. In a fourth step, the control module can process the sequence of images to determine a phase corresponding to a black region of the black-and-white stripe pattern for each pixel. In a fifth step, the control module can construct a white-region image based on each pixel of a corresponding gray-level value in the blurred sequence of images. In a sixth step, the control module can generate a reconstructed image of the black-and-white pattern by subtracting the black-region image from the white-region image. Of significant note, the reconstructed image can have reduced edge artifacts.

In one instance, the processing can include, but is not limited to, (i) blurring the sequence of images across the phase dimension, (ii) comparing blurred pixel values across all phase offsets for each pixel, and (iii) identifying a darkest pixel value within the blurred sequence of images for each pixel. The darkest pixel value representing a phase offset corresponding to an interior portion of a black region of the black-and-white stripe pattern; constructing a black-region image based on each pixel of a corresponding darkest pixel value. The blurring may be applied temporally across phase offsets.

In yet another example embodiment, a display device-camera calibration pipeline may include at least three methods: a first method implemented for mapping display device UV coordinates to camera UV coordinates; a second method implemented for mitigating a camera having auto-exposure; and a third method for transmitting and reconstructing a signal to reduce edge artifacts.

The first method can include, but is not limited to, the following steps. In a first step, at least one display device, at least one camera, and a control module can be provided. In a second step, by the at least one display device, displaying a plurality of wavelet patterns one at a time, the plurality of wavelet patterns corresponding to horizontally oriented frequency bands and vertically oriented frequency bands of the display device. In a third step, by the at least one camera, capturing a positive image and an inverted image for each wavelet pattern of the plurality of wavelet patterns. In a fourth step, by the control module, (i) computing a plurality of difference images by subtracting a negative image from a positive image for each wavelet pattern of the plurality of wavelet patterns and applying a threshold to the plurality of difference images about zero to classify pixels as representing a white region, a black region, or an invalid region, and (ii) combining classification results for each of the plurality of difference images to identify pairs of display UV coordinates and corresponding camera UV coordinates.

The second method can include, but is not limited to, the following steps. In a first step, by the control module, receiving an input signal representing a black-and-white test pattern comprising a white region and a black region and transforming the input signal into a first transformed pattern by converting the white region into alternating black-and-white stripes and converting the black region into a gray region. In a second step, by the display device and the camera, displaying the first transformed pattern and capturing a first image, the first image of the first transformed pattern. In a third step, by the control module, transforming the first transformed pattern into a second transformed pattern by applying a phase shift of approximately 180 degrees to the alternating black-and-white stripes of the first transformed pattern. In a fourth step, by the display device and the camera, displaying the second transformed pattern and capturing a second image, the second image of the second transformed pattern. In a fifth step, by the control module, combining the first image and the second image using a maximum-value operator to generate a first combined image. In a sixth step, by the display device, the camera, and the control module, performing the transforming, displaying, capturing, and combining steps for an inverted version of the input signal to generate a second combined image. In a seventh step, by the control module, reconstructing a modified original black-and-white test pattern by subtracting the first combined image from the second combined image to produce a reconstructed image corresponding to the input signal.

The third method can include, but is limited to, the following steps. In a first step, by the control module, generating a sequence of black-and-white stripe patterns, each black-and-white stripe pattern being drawn with a different phase offset, the phase offsets collectively spanning approximately 360 degrees. In a second step, by the display device and camera, displaying the sequence of black-and-white stripe patterns and capturing a corresponding sequence of images, each image associated with a respective phase offset. In a third step, by the control module, (i) processing the sequence of images to determine a phase corresponding to a black region of the black-and-white stripe pattern for each pixel constructing a black-region image based on each pixel of a corresponding darkest pixel value, (ii) constructing a white-region image based on each pixel of a corresponding gray-level value in the blurred sequence of images, and (iii) generating a reconstructed image of the black-and-white pattern by subtracting the black-region image from the white-region image. The reconstructed image can have reduced edge artifacts.

The step of processing can include, but is not limited to, (i) blurring the sequence of images across the phase dimension, (ii) comparing blurred pixel values across all phase offsets for each pixel, and (iii) identifying a darkest pixel value within the blurred sequence of images for each pixel. The darkest pixel value can represent a phase offset corresponding to an interior portion of a black region of the black-and-white stripe pattern.

The present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device.

The computer-usable or computer-readable medium can be, but is not limited to, an electronic, magnetic, optical, electromagnetic, infrared, or semiconductor system, apparatus, device, or propagation medium.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

### An Embodiment of a Display Device-Camera Calibration System

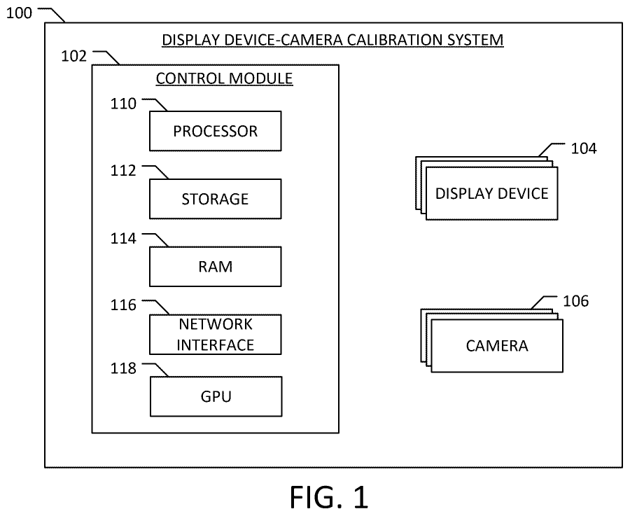

Referring to FIG. 1, a block diagram of an embodiment 100 of a display device-camera calibration (DDC) system is illustrated. The DDC calibration system 100 can be implemented to provide simplified image processing to cancel out ambient light, background texture, and brightness differences when calibrating a display device. In one instance, the DDC calibration system 100 can be part of a display device-camera calibration pipeline. Of note, one or more methods described herein may be applicable outside of the display device-camera calibration pipeline. The DDC calibration system 100 can implement resilient image capture techniques across varying stages of the pipeline.

As shown, the DDC calibration system 100 can include, but is not limited to, a control module 102, one or more display devices 104, and one or more cameras 106. The one or more display devices 104 and the one or more cameras 106 can be operatively connected to the control module 102. In some instances, components of the system 100 may be located remotely from one another.

In one example, the control module 102 can represent a server or another powerful, dedicated computer system that can support multiple user sessions. In some embodiments, the control module 102 can be any type of computing device including, but not limited to, a personal computer, a game console, a smartphone, a tablet, a netbook computer, or other computing devices. In one embodiment, the control module 102 can be a distributed system wherein control module functions are distributed over several computers connected to a network. The control module 102 can typically include hardware components and software components.

The software components of the control module 102 can include, but are not limited to, an operating system, one or more applications or programs operable on the operating system, and one or more databases for storing data. In one embodiment, the one or more applications can include an application dedicated to image acquisition and processing for calibrating the one or more display devices 104. For instance, the application can follow a process (or method) similar to the method described hereinafter as the image processing method. Typically, the one or more applications can include a control application configured to receive, store, and send data and information created by the one or more applications. In one example, the control application can oversee (or manage) the display device-camera calibration pipeline and how data is used in the pipeline. The control application can include logic for determining when to implement the applications described hereinafter and when to send data from one application to another application. For instance, the control application may receive an image created by a first process and provide the image to a second process (e.g., edge refinement).

The hardware platform of the control module 102 can include, but is not limited to, a processor 110, nonvolatile storage 112, random access memory 114, a network interface 116, and a graphics processing unit 118. The processor 110 can be a single microprocessor, multi-core processor, or a group of processors. The random access memory 114 can store executable code as well as data that can be immediately accessible to the processor 120. The nonvolatile storage 112 can store executable code and data in a persistent state. The hardware platform can include a user interface. The user interface may include keyboards, monitors, touch screens, pointing devices, and other user interface components. In one embodiment, the user interface may be a touch input (or touch screen). The graphics processing unit (GPU) 118 can be implemented as a specialized processor designed to accelerate graphics and image processing by performing large numbers of calculations in parallel.

The network interface 116 can include, but is not limited to, hardwired and wireless interfaces through which the control module 102 can communicate with other devices. As can be appreciated, the network may be any type of network, such as a local area network, wide area network, or the Internet. In some cases, the network can include wired or wireless connections and may transmit and receive information using various protocols.

The one or more display devices 104 can be implemented to display an image, animation, video, etc. from the control module 102. The display devices 104 can be implemented to display images from the control module 102 to be captured by the one or more cameras 106. The one or more display devices 104 can include any output device that presents information visually. For instance, the display device 104 may be a monitor, a television, a smartphone, a tablet, a projector, an e-paper, segment displays, LED displays and more.

As previously mentioned, the control module 102 can include one or more applications configured to process images to calibrate the one or more display devices 104. The one or more applications can implement the components of the previously mentioned system 100 and various image processing techniques to calibrate the one or more display devices 104 for real world situations. Of significant note, the described methods (or processes) can be implemented to address non-ideal lighting environments for calibrating display devices. Non-ideal lighting, in the context of display calibration, can refer to viewing environments that deviate from the controlled and standardized conditions required to achieve accurate and repeatable color measurements. For instance, real world situations where ambient light from one or more sources that are not controllable may be considered to deviate from controlled and standardized conditions. Ideal lighting calibration conditions can typically assume a stable and predictable environment. When the lighting is not controlled, the measurements can become unreliable.

The DDC calibration system 100 can be implemented in the display device-camera calibration pipeline configured to implement one or more methods that enable (i) accurate mapping between display UV coordinates and camera UV coordinates, (ii) robust operation under auto-exposure conditions of a camera, and (iii) improved reconstruction of signals with reduced edge artifacts. The display device-camera calibration pipeline may include, but is not limited to, a first method for image processing, a second method for UV mapping between a display device and camera, a third method for compensation of an auto-exposure camera, and a fourth method for transmitting and reconstructing signals to mitigate distortions caused by camera exposure and image-processing corrections.

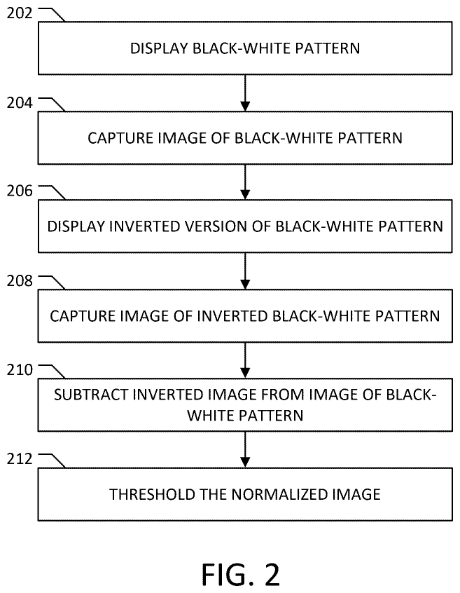

Referring to FIG. 2, a flow diagram of an embodiment 200 of an image processing method is illustrated. The image processing method 200 can be implemented to normalize an image to zero regardless of real-world lighting conditions for the display device 104. Of note, the DDC calibration system 100 can be configured to implement the image processing method 200 as an application. Of significant note, the image processing method 200 can be used by each of the applications described hereinafter.

In a block 202, the display device 104 can be configured to display a black-white pattern. The black-white pattern can generally include a black region and a white region. Of note, a pattern of the black-white pattern can be selected based on a stage of the display device-camera calibration pipeline.

In a block 204, the camera can be used to capture an image of the displayed black-white pattern. In some instances, a real camera can be used. In other instances, a virtual camera can be used. Of note, depending on settings of the camera, a second method can be implemented to augment auto-exposure settings of the camera.

In a block 206, the control module 102 can generate an inverted version of the black-white pattern and the display device 104 can display the inverted black-white pattern.

In a block 208, the camera can be used to capture an image of the inverted black-white pattern.

In a block 210, the control module can be configured to process the captured images to generate a normalized image by subtracting the inverted image from the original image of the black-white pattern.

In a block 212, the normalized image can be thresholded. Of significant note, by subtracting the inverted image from the original image, the control module can normalize the image about zero such that each successive image normalized can have similar parameters for determining white regions, black regions, and invalid regions that are above a threshold for either the white region or black region.

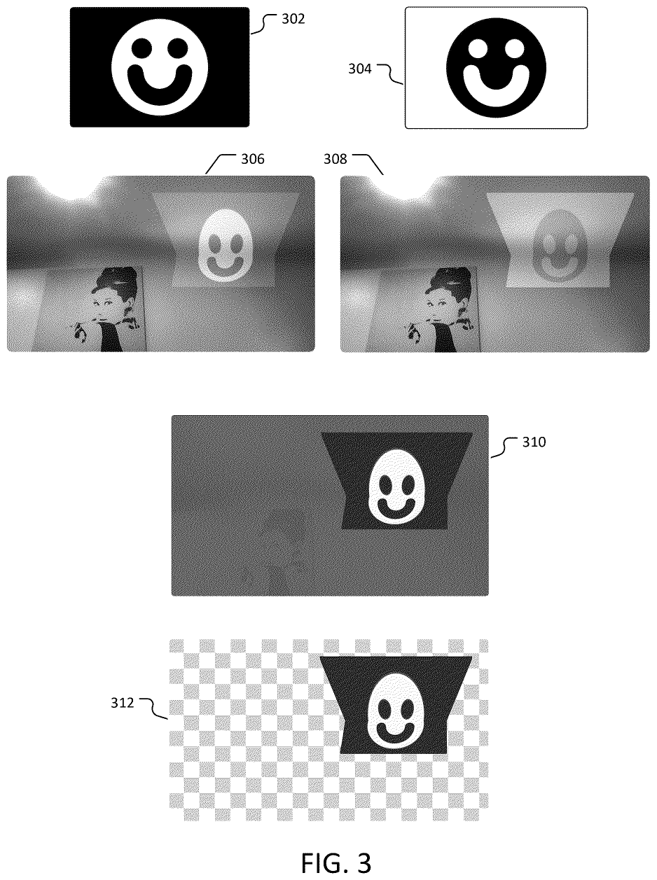

Referring to FIG. 3, multiple images 302-312 signifying the steps of the image processing method 200 are illustrated. As shown, a first black-white pattern 302 can be implemented by the system 100. In this example, the first black-white pattern 302 can be a black and white smiley face pattern. Finding a threshold for determining if any given pixel is white or black is difficult, the black part of the pattern could be brighter than the white part if there is ambient light or a nonuniformity. If ambient light is on parts of the display and the display itself has non-uniform brightness due to display characteristics and position this greatly exacerbates the problem as an example.

The control module 102 can be implemented to create a normal version of the smiley face 302 and an inverted version 304 of the smiley face. The control module 102 (or another device) can have the display 104 display the smiley faces 302, 304 in an environment. A capture by the camera 106 of the normal version smiley face 306 being displayed in the environment is shown in a first image 306. A capture by the camera of the inverted smiley face 304 being displayed in the environment is shown in a second image 308. Of significant note, the environment may have non-ideal lighting for calibrating the display 104. Of note, the environment may have ambient light and background clutter, glare, etc. In some instances, the display may have a smaller dynamic range than the camera. This can lead to the displayed image looking washed out. As can be appreciated, the display may not be the brightest or darkest part of the image.

Next, the control module 102 can create a normalized image by subtracting the inverted image 308 from the normal image 306 and is shown in a third image 310. As can be appreciated, the third image 310 can be normalized to zero. However, to interpret the third image 310, the positive parts of the third image 310 are shown as white, the negative parts of the third image 310 are shown as black, and the near zero values of the third image 310 are shown as gray. Any part of the image that is positive and above a threshold can be assumed to be a white part of the image. Any part of the image that is negative and below a threshold can be assumed to be the black part of the image. Values near zero within a threshold can be assumed to be background or outside the image and the control module 102 can mark these as NaN (or clear). A thresholded image 312 shows a checkerboarded area that represents the area considered invalid or outside the image.

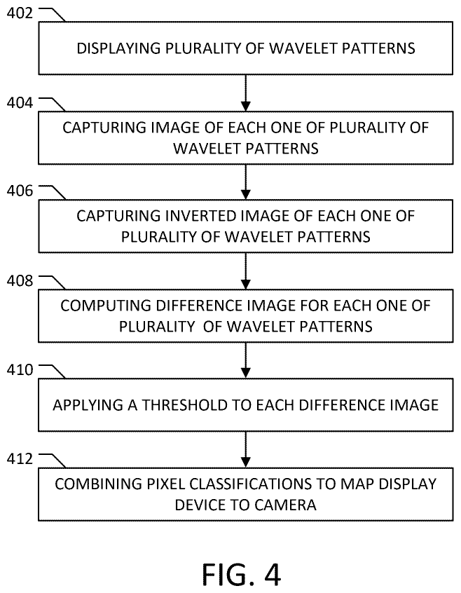

Referring to FIG. 4, a flow diagram of an embodiment 400 of a method to provide accurate mapping between display UV coordinates and camera UV coordinates is illustrated. Of note, the DDC calibration system 100 can be configured to implement the mapping method 400 as an application. The DDC calibration system 100 can be implemented to characterize the mapping between a displayed image from the display device 104 and the camera 106. Wavelets are a frequency space methodology to represent a signal and can be used in the 2D case for mapping the relationship between camera pixels and display UV coordinates. Instead of photographing each display pixel drawn one at a time, the system 100 can be configured to draw wavelets and photograph the wavelets that correspond to frequency bands of the display device 104. Typically, the control module 102 can have the display device 104 display one set of wavelets for horizontal bands and one set of wavelets for vertical bands. By combining the wavelets, the control module 102 can be configured to find camera UV coordinates that correspond to a specific row and column of the display UV coordinates. As can be appreciated, this can create a mapping between display UV coordinates and camera UV coordinates. In one example, the system 100 can implement Haar wavelets. Haar wavelets can be a square wave that alternates between 100% white and 0% white (or black).

In block 402, the display device 106 can be configured to display a plurality of wavelet patterns. Typically, the plurality of wavelet patterns can be displayed one at a time. Of significant note, the plurality of wavelet patterns can correspond to horizontally oriented frequency bands and vertically oriented frequency bands of the display device;

In block 404, the camera 106 can capture a positive image for each wavelet pattern of the plurality of wavelet patterns.

In block 406, the camera 106 can capture an inverted image for each wavelet pattern of the plurality of wavelet patterns.

In block 408, the control module 102 can compute a plurality of difference images by subtracting an inverted image from a positive image for each wavelet pattern of the plurality of wavelet patterns. Of note, a difference image can be computed for each wavelet pattern.

In block 410, the control module 102 can apply a threshold to the plurality of difference images about zero to classify pixels as representing a white region, a black region, or an invalid region.

In block 412, the control module 102 can combine classification results for each of the plurality of difference images to identify pairs of display device UV coordinates and corresponding camera UV coordinates. By identifying pairs of corresponding coordinates, the control module 102 can map the display device UV coordinates to the camera UV coordinates.

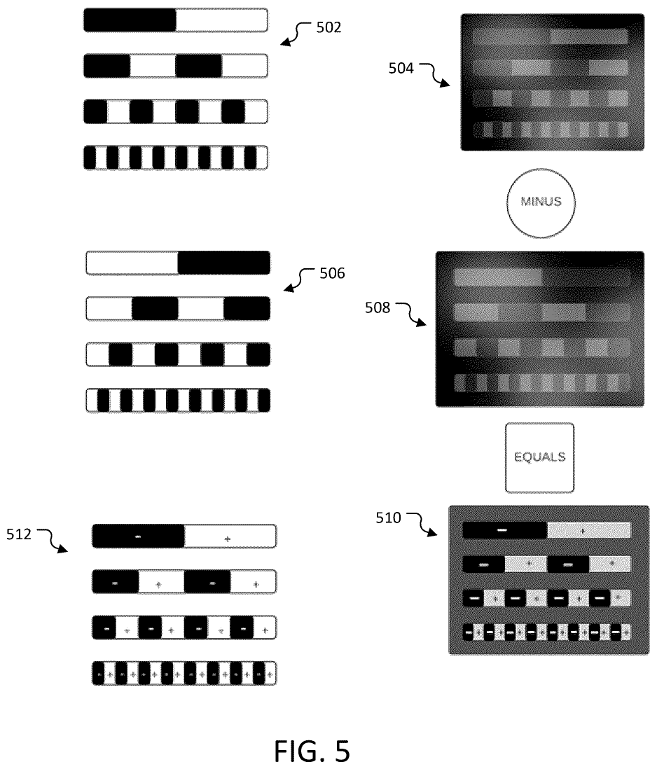

Referring to FIG. 5, multiple images 502-512 signifying the steps of the mapping method 200 are illustrated in one dimension. In this example, the control module 102 can be configured to draw positive wavelets as shown in a first image 502 and inverted wavelets as shown in a second image 506. The camera 106 can be configured to capture images of the positive wavelets as shown in a third image 504 and the inverted wavelets as shown in a fourth image 508. The third image 504 and the fourth image 508 may be the result from multiple images for denoising purposes. The control module 102 may be configured to compute a difference image by subtracting the fourth image 508 from the third image 504. As can be appreciated, this is typically done in an in an image format that can handle negative values. A fifth image 510 can be the result of the computing by the control module 102. Values above a small threshold value can be considered to be part of the white part of the pattern. Negative values below the small threshold value are considered to be part of the black part of the pattern. Values near zero within the threshold are considered to be invalid data (or outside of the display pattern). A thresholded image 512 can be implemented by the control module 102 as one input for mapping. The positive-negative image processing can be implemented to simplify the threshold level. As can be appreciated, everything can now be centered around zero. The control module 102 can use a threshold level on the difference from zero, but now this threshold can be used globally equally well for bright areas and dark areas. As previously mentioned, this can be applied for horizontal wavelets and vertical wavelets. By combining the horizontal wavelet images and the vertical wavelet images the control module 102 can create a set of display device UV coordinates to camera UV coordinates. In some instances, the control module 102 can keep track of invalid nodes and allow an operator to mark regions as invalid or override collected data. Further, as the wavelets are representative of the display devices UV coordinates, but captured by the camera, the control module 102 can smooth and interpolate and extrapolate the dataset to fill in missing information. In one instance, the images can be stored in floating point that can be negative, positive, or NaN. The control module 102 can be configured to use this directly to map an image in camera space to display space or use raytracing to do perspective projection mapping for mapping a viewer's perspective of a virtual environment to an immersive display.

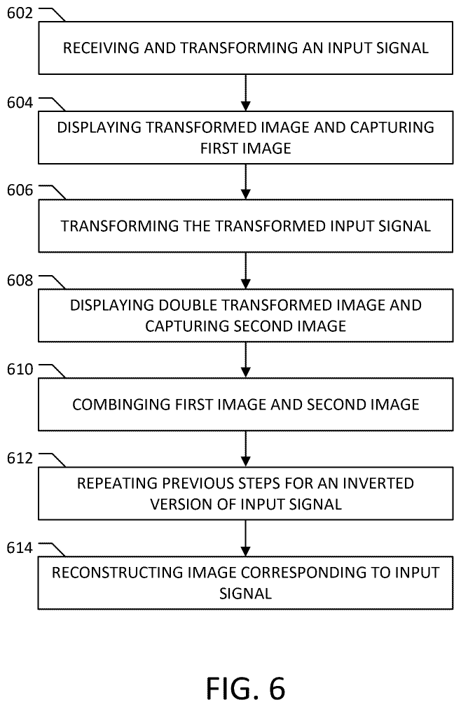

Referring to FIG. 6, a flow diagram of a method 600 for mitigating cameras having auto-exposure is illustrated. The auto-exposure method 600 can be implemented to ensure cameras having auto-exposure do not alter images when captured.

In block 602, the control module 102 can receive an input signal and can transform the input signal. The input signal can represent a black-and-white test pattern having a white region and a black region. The control module 102 can transform the input signal into a first transformed pattern by converting the white region into alternating black-and-white stripes and converting the black region into a gray region.

In block 604, the display device 104 can display the first transformed pattern and the camera 106 can capture a first image. The first image can be of the first transformed pattern.

In block 606, the control module 102 can transform the first transformed pattern into a second transformed pattern by applying a phase shift of approximately 180 degrees to the alternating black-and-white stripes of the first transformed pattern.

In block 608, the display device 104 can display the second transformed pattern and the camera 106 can capture a second image. The second image can be of the second transformed pattern.

In block 610, the control module 102 can combine the first image and the second image using a maximum-value operator to generate a first combined image.

In block 612, the steps of transforming, displaying, capturing, and combining can be performed for an inverted version of the input signal to generate a second combined image.

In block 614, the control module 102 can reconstruct the original black-and-white test pattern by subtracting the first combined image from the second combined image to produce a reconstructed image corresponding to the input signal.

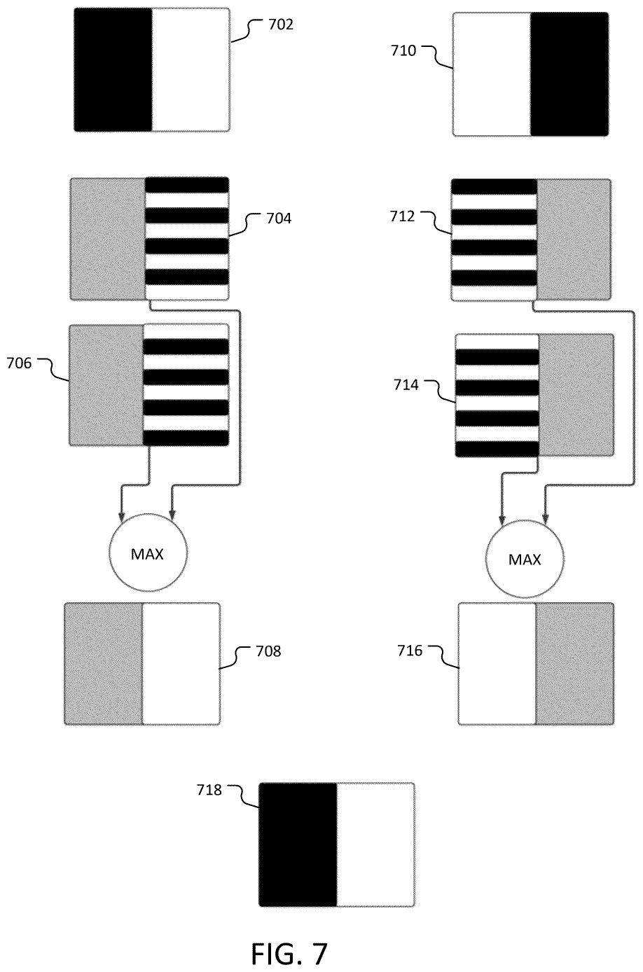

Referring to FIG. 7, multiple images 702-718 signifying the steps of the auto-exposure mitigation method 600 are illustrated. For instance, the method 600 can be implemented to prevent changes on cameras that are set to auto-exposure. Many commodity cameras (e.g., network cameras) are configured to have auto-exposure. The images 702-718 illustrate how the control module 102 can be configured to reconstruct a black and white test pattern from the transformed images. Using such an image helps balance the exposure so that even if the pattern changes shape, the overall brightness of the image remains constant enough to keep the auto-exposure from changing.

As is shown, instead of showing white and black test patterns (images 702 and 710), the test patterns can be transformed where the white regions becomes black and white strips and the black region becomes a 50% grey region, as shown in images 704-706, 712-714. In one instance, this can be computed to be the 50% brightness not by RGB value, but respecting the gamma of the display device. The camera 106 can then capture an image of the result. Typically, the overall brightness should be 50% (e.g., 25% white, 25% black, 50% gray), and as long as the control module 102 can keep those ratios, the exposure should maintain a single level.

Next, the control module 102 can transform the original signal by offsetting the phase of the black and white pattern by 180 degrees (e.g., instead of the black and white pattern starting with black it starts with white). The camera 106 can then capture one or more images of the transformed pattern. After capturing the transformed images 704,706, the control module 102 can merge the images using a max operator. The max of the images 704,706 can be the image 708. Next, the control module 102 can repeat for an inverted version of the transformed patterns as shown in it images 712,714. The inverted images 712,714 can be merged using a max operator. The max of the inverted images 712,714 can be image 716. Finally, the control module 102 can reconstruct the original signal by subtracting the image 708 from the inverted image 716 to get the image 718.

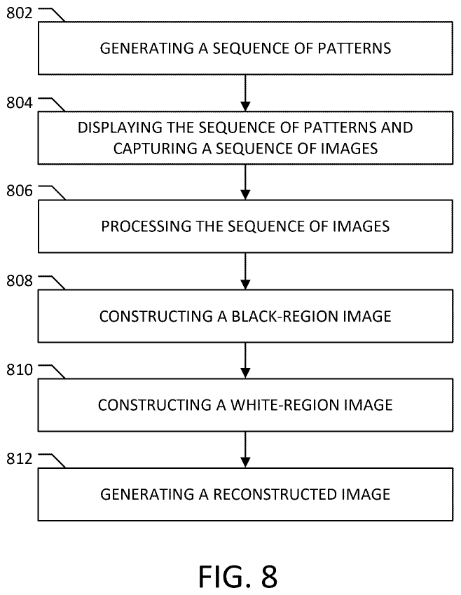

Referring to FIG. 8, a flow diagram of a method 800 for edge reconstruction is illustrated. The edge reconstruction method 800 can be implemented to alleviate problems in certain cameras related to signal degradation. More specifically, in certain cameras, the pattern that is displayed is not what is captured by the camer. For instance, the pattern may be transformed by optical aberrations such as lens blur or resolution differences. The pattern may be distorted by digital sharpening or compression artifacts. The exact shape of the displayed pattern can be changed by unwanted image processing. The problem can be exacerbated by previously described image processing methods.

In block 802, the control module 102 can generate a sequence of black-and-white stripe patterns, each black-and-white stripe pattern being drawn with a different phase offset, the phase offsets collectively spanning approximately 360 degrees. The black-and-white stripe pattern is drawn with a phase offset. We take photos for each phase offsets

In block 804, the display device 104 can display the sequence of black-and-white stripe patterns and the camera 106 can capture a corresponding sequence of images. Each image can be associated with a respective phase offset. Images can be captured until the full 360 phase is finished. For example, seven steps would be 360/7 degrees in phase offset.

In block 806, the control module 102 can process the sequence of images to determine a phase corresponding to a black region of the black-and-white stripe pattern for each pixel. In one instance, the processing can include, but is not limited to, (i) blurring the sequence of images across the phase dimension, (ii) comparing blurred pixel values across all phase offsets for each pixel, and (iii) identifying a darkest pixel value within the blurred sequence of images for each pixel, the darkest pixel value representing a phase offset corresponding to an interior portion of a black region of the black-and-white stripe pattern. By blurring the image sequence across phase, the control module 102 can reduce a false edge and can convert a hard edge to a smooth transition. The control module 102 can compare all of the phases individually for each pixel. The control module 102 can then identify the darkest pixel value in the blurred phase that can represent the phase offset for that pixel. This can allow the control module 102 to find the interior of the black part of a stripe. When applied to the entire image, the control module 102 can capture the black part of the pattern as the darkest phase of the striped area and the white part of the pattern as the gray part of the image.

In block 808, the control module 102 can construct a black-region image based on each pixel of a corresponding darkest pixel value in the blurred sequence of images.

In block 810, the control module 102 can construct a white-region image based on each pixel of a corresponding gray-level value in the blurred sequence of images.

In block 812, the control module 102 can generate a reconstructed image of the black-and-white pattern by subtracting the black-region image from the white-region image. Of note, the reconstructed image can have reduced edge artifacts.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

We claim:

1. A display device-camera calibration pipeline including at least one method, the pipeline including a first method for mapping display device UV coordinates to camera UV coordinates in non-ideal lighting conditions, the first method comprising:
displaying a first set of horizontal wavelet patterns by a display device;
capturing a first image, the first image of the first set of horizontal wavelet patterns by a camera;
displaying an inverted version of the first set of horizontal wavelet patterns by the display device;
capturing a second image, the second image of the inverted version of the first set of horizontal wavelet patterns by the camera;
computing a first difference image by subtracting the second image from the first image by a control module;
displaying a first set of vertical wavelet patterns by the display device;
capturing a third image, the third image of the first set of vertical wavelet patterns by the camera;
displaying an inverted version of the first set of vertical wavelet patterns by the display device;
capturing a fourth image, the fourth image of the inverted version of the first set of vertical wavelet patterns by the camera;
computing a second difference image by subtracting the fourth image from the third image by the control module;
applying a threshold to the first difference image and the second difference image to classify pixels in each image as white or black; and
combining the pixel classifications to determine a display device-to-camera mapping.

2. The method of claim 1, further including the steps of:
displaying a second set of horizontal wavelet patterns by the display device;
capturing a fifth image, the fifth image of the second set of horizontal wavelet patterns by a camera;
displaying an inverted version of the second set of horizontal wavelet patterns by the display device;
capturing a sixth image, the sixth image of the inverted version of the second set of horizontal wavelet patterns by the camera; and
computing a third difference image by subtracting the sixth image from the fifth image by a control module.

3. The method of claim 2, further including the steps of:
displaying a second set of vertical wavelet patterns by the display device;
capturing a seventh image, the seventh image of the second set of vertical wavelet patterns by the camera;
displaying an inverted version of the second set of vertical wavelet patterns by the display device;
capturing an eighth image, the eighth image of the inverted version of the second set of vertical wavelet patterns by the camera;
computing a fourth difference image by subtracting the eighth image from the seventh image by the control module.

4. The method of claim 3, wherein the steps of displaying, capturing, and computing are repeated for at least 5 different sets of horizontal wavelet patterns and 5 different sets of vertical wavelet patterns to create 10 difference images.

5. The method of claim 4, wherein the steps of applying the threshold and combining the pixel classifications are completed after 10 difference images are computed.

6. The method of claim 5, further comprising the step of:
selecting a highest threshold margin from the 10 difference images and using the selected highest threshold margin as the threshold.

7. The method of claim 1, further including the step of:
encoding spatial positions of display device pixels by associating each set of wavelet patterns with a bit position of a binary index.

8. The method of claim 7, wherein a combination of corresponding horizontal sets of wavelet patterns and vertical sets of wavelet patterns identifies a unique horizontal position and a unique vertical position of the binary index.

9. The method of claim 8, wherein each bit position corresponds to a white region or black region of one of the sets of wavelet patterns.

10. A display device-camera calibration pipeline including two or more methods, the pipeline including a first method for mapping display device UV coordinates to camera UV coordinates, the first method comprising:
providing a display device, a camera, and a control module;
displaying a plurality of wavelet patterns one at a time, the plurality of wavelet patterns corresponding to horizontally oriented frequency bands and vertically oriented frequency bands of the display device;
capturing a positive image and an inverted image for each wavelet pattern of the plurality of wavelet patterns;
computing a plurality of difference images by subtracting an inverted image from a positive image for each wavelet pattern of the plurality of wavelet patterns;
applying a threshold to the plurality of difference images about zero to classify pixels as representing a white region, a black region, or an invalid region; and
combining classification results for each of the plurality of difference images to identify pairs of display device UV coordinates and corresponding camera UV coordinates.

11. The method of claim 10, further including the steps of:
recording the identified pairs to form a mapping between display device UV coordinates and camera UV coordinates; and
processing the recorded mapping to fill missing or invalid entries by smoothing, interpolating, or extrapolating the recorded pairs.

12. The method of claim 10, wherein the step of applying a threshold to the plurality of difference images includes:
identifying positive valued pixels of the difference image having values above a first threshold and classifying the positive valued pixels as corresponding to white regions of the first pattern;
identifying negative valued pixels of the difference image having values below a second threshold and classifying the negative valued pixels as corresponding to black regions of the first pattern;
identifying near-zero-valued pixels of the difference image having values within a third threshold range about zero and classifying the near-zero-valued pixels as invalid regions; and
generating a thresholded image defined by (i) pixels corresponding to the white regions, (ii) pixels corresponding to the black regions, and (iii) pixels marked as invalid.

13. The method of claim 10, the display device-camera calibration pipeline including a second method for the camera having auto-exposure, the second method comprising the steps of:
receiving an input signal representing a black-and-white test pattern comprising a white region and a black region;
transforming the input signal into a first transformed pattern by:
converting the white region into alternating black-and-white stripes; and
converting the black region into a gray region;
displaying the first transformed pattern and capturing a first image, the first image of the first transformed pattern;
transforming the first transformed pattern into a second transformed pattern by applying a phase shift of approximately 180 degrees to the alternating black-and-white stripes of the first transformed pattern;
displaying the second transformed pattern and capturing a second image, the second image of the second transformed pattern;
combining the first image and the second image using a maximum-value operator to generate a first combined image;
performing the transforming, displaying, capturing, and combining steps for an inverted version of the input signal to generate a second combined image; and
reconstructing the original black-and-white test pattern by subtracting the first combined image from the second combined image to produce a reconstructed image corresponding to the input signal.

14. The second method of claim 13, wherein the gray region has approximately 50% brightness as determined according to a gamma characteristic of the display device.

15. The second method of claim 13, wherein the first image has an overall brightness comprising approximately 25% white, 25% black, and 50% gray.

16. The method of claim 10, the display device-camera calibration pipeline including a third method for transmitting and reconstructing a signal to reduce edge artifacts, the method comprising:
generating a sequence of black-and-white stripe patterns, each black-and-white stripe pattern being drawn with a different phase offset, the phase offsets collectively spanning approximately 360 degrees;
displaying the sequence of black-and-white stripe patterns and capturing a corresponding sequence of images, each image associated with a respective phase offset;
processing the sequence of images to determine a phase corresponding to a black region of the black-and-white stripe pattern for each pixel, the processing comprising:
blurring the sequence of images across the phase dimension;
comparing blurred pixel values across all phase offsets for each pixel; and
identifying a darkest pixel value within the blurred sequence of images for each pixel, the darkest pixel value representing a phase offset corresponding to an interior portion of a black region of the black-and-white stripe pattern;
constructing a black-region image based on each pixel of a corresponding darkest pixel value in the blurred sequence of images;
constructing a white-region image based on each pixel of a corresponding gray-level value in the blurred sequence of images; and
generating a reconstructed image of the black-and-white pattern by subtracting the black-region image from the white-region image, the reconstructed image having reduced edge artifacts.

17. The method of claim 16, wherein the step of blurring is applied temporally across phase offsets.

18. A display device-camera calibration pipeline including at least three methods, a first method implemented for mapping display device UV coordinates to camera UV coordinates, a second method for a camera having auto-exposure, and a third method for transmitting and reconstructing a signal to reduce edge artifacts, the first method comprising:
providing at least one display device, at least one camera, and a control module;
by the at least one display device:
displaying a plurality of wavelet patterns one at a time, the plurality of wavelet patterns corresponding to horizontally oriented frequency bands and vertically oriented frequency bands of the display device;
by the at least one camera:
capturing a positive image and an inverted image for each wavelet pattern of the plurality of wavelet patterns;
by the control module:
computing a plurality of difference images by subtracting a negative image from a positive image for each wavelet pattern of the plurality of wavelet patterns;
applying a threshold to the plurality of difference images about zero to classify pixels as representing a white region, a black region, or an invalid region; and
combining classification results for each of the plurality of difference images to identify pairs of display device UV coordinates and corresponding camera UV coordinates.

19. The second method of claim 18, the second method comprising the steps of:
by the control module:
receiving an input signal representing a black-and-white test pattern comprising a white region and a black region; and
transforming the input signal into a first transformed pattern by:
converting the white region into alternating black-and-white stripes; and
converting the black region into a gray region;
by the display device and the camera:
displaying the first transformed pattern; and
capturing a first image, the first image of the first transformed pattern;
by the control module:
transforming the first transformed pattern into a second transformed pattern by applying a phase shift of approximately 180 degrees to the alternating black-and-white stripes of the first transformed pattern;
by the display device and the camera:
displaying the second transformed pattern;
capturing a second image, the second image of the second transformed pattern;
by the control module:
combining the first image and the second image using a maximum-value operator to generate a first combined image;
by the display device, the camera, and the control module:
performing the transforming, displaying, capturing, and combining steps for an inverted version of the input signal to generate a second combined image;
by the control module:
reconstructing a modified original black-and-white test pattern by subtracting the first combined image from the second combined image to produce a reconstructed image corresponding to the input signal.

20. The third method of claim 18, the third method comprising steps of:
by the control module:
generating a sequence of black-and-white stripe patterns, each black-and-white stripe pattern being drawn with a different phase offset, the phase offsets collectively spanning approximately 360 degrees;
by the display device and camera:
displaying the sequence of black-and-white stripe patterns and capturing a corresponding sequence of images, each image associated with a respective phase offset;
by the control module:
processing the sequence of images to determine a phase corresponding to a black region of the black-and-white stripe pattern for each pixel, the processing comprising:
blurring the sequence of images across the phase dimension;
comparing blurred pixel values across all phase offsets for each pixel; and
identifying a darkest pixel value within the blurred sequence of images for each pixel, the darkest pixel value representing a phase offset corresponding to an interior portion of a black region of the black-and-white stripe pattern;
constructing a black-region image based on each pixel of a corresponding darkest pixel value;
constructing a white-region image based on each pixel of a corresponding gray-level value in the blurred sequence of images; and
generating a reconstructed image of the black-and-white pattern by subtracting the black-region image from the white-region image, the reconstructed image having reduced edge artifacts.
